(19) United States
(12) Patent Application Publication
(10) Pub. No.: US 2009/0301795 A1
(43) Pub. Date: Dec. 10, 2009

(54) Electronic device and controlling method thereof

(75) Inventor: Chueh-Pin Ko, Taipei Hsien (TW)

Correspondence Address: Juan Carlos A. Marquez;c/o Stites & Harbison PLLC, 1199 North Fairfax Street, Suite 900, Alexandria, VA, 22314-1437, US

(73) Assignee: Acer Incorporated

(21) Appl. No.: 12/289,387

(22) Filed: Oct. 27, 2008

(30) Foreign Application Priority Data
Jun. 6, 2008 (TW) 97121061

(51) Int. Cl. G06F 3/041

(52) U.S. Cl. 178/18.03

(57) ABSTRACT

Provided is an electronic device and a controlling method thereof. The electronic device includes: a first touch unit, a second touch unit, a processing circuit, and a central control unit. The method includes the following steps: (A) in response to user's first action, the first touch unit generates a first signal; (B) in response to user's second action, the second touch unit generates a second signal; (C) in response to the first signal and the second signal, the processing circuit generates a control instruction; and (D) in response to the control instruction, the central control unit implements an application.

### CROSS REFERENCE TO RELATED APPLICATIONS

This application claims the right of priority based on Taiwan Patent Application No. 097121061, filed on Jun. 6, 2008, which is incorporated herein by reference and assigned to the assignee herein.

### FIELD OF THE INVENTION

The present invention is related to an electronic device and a controlling method for the same, especially to an electronic device with a combination touch unit and a controlling method for the same.

### BACKGROUND OF THE INVENTION

The conventional electronic device or electronic equipment is configured with mechanical or spring buttons, etc., so that users can only press one of the buttons with more force in use. If users need to press two of the buttons at the same time, the pressing is not convenient in use.

So far, the touch button technology has been mature. It is to provide users with a resistive, acoustic wave, optics, electromagnetism or electrostatic button such that users press the button easily to generate input signals. According to the pressing type classification of buttons, they can be classified into 0D (zero-dimensional), 1D (one-dimensional), and 2D (two-dimensional). Generally, the electronic device, such as a cellphone, can be configured with 0D, 1D, and 2D buttons. However, users only press one of them one time to transmit a control instruction, but simultaneously use two of them not to generate another one. Therefore, the electronic device is not convenient in use.

In order to make users easier to use between difference touch units so as to implement any functions in the electronic device, an electronic device and a controlling method for the same are desired.

### SUMMARY OF THE INVENTION

To solve the above-mentioned problems, the present invention is to provide an electronic device and a controlling method for the same for making users easier to use between difference touch units so as to implement any functions in the electronic device.

One aspect of the present invention is to provide an electronic device, comprising: a first touch unit for generating a first signal in response to a user's first action; a second touch unit not connecting with the first touch unit, for generating a second signal in response to the user's second action; a processing circuit for generating a control instruction in response to the first signal and the second signal; and a central control unit for implementing an application in response to the control instruction.

Another aspect of the present invention is to provide a controlling method for an electronic device, wherein the electronic device comprises a first touch unit, a second touch unit, a processing circuit and a central control unit, wherein the second touch unit is not connecting with the first touch unit, the controlling method comprising: (A) generating a first signal by the first touch unit in response to a user's first action; (B) generating a second signal by the second touch unit in response to the user's second action; (C) generating a control instruction by the processing circuit in response to the first signal and the second signal; and (D) implementing an application by the central control unit in response to the control instruction.

### BRIEF DESCRIPTION OF THE DRAWINGS

FIGS. 1A and 1B show block diagrams of an electronic device in accordance with a first and a second embodiments of the present invention respectively.

FIG. 2A shows a schematic illustration for using an electronic device in accordance with a first embodiment of the present invention.

FIG. 2B shows a touch time diagram of an electronic device in accordance with a first embodiment of the present invention.

FIG. 3 shows a mapping table of an electronic device in accordance with a first embodiment of the present invention.

FIG. 4 shows a flowchart of a controlling method in accordance with a first embodiment of the present invention.

FIG. 5 shows a schematic illustration of operation for an electronic device in accordance with a second embodiment of the present invention.

FIG. 6 shows a schematic illustration for illustrating parts of a mapping table in accordance with a second embodiment of the present invention.

FIG. 7 shows a flowchart of a controlling method in accordance with a second embodiment of the present invention.

### DETAILED DESCRIPTION OF THE INVENTION

Other objects, advantages, and novel features of the invention will become more apparent from the following detailed description when taken in conjunction with the accompanying drawings. In the embodiments of the present invention, the same or like reference numbers will be used throughout the drawings to refer to the same or like parts. Moreover, it is to be understood that the present invention is not limited to the disclosed embodiments.

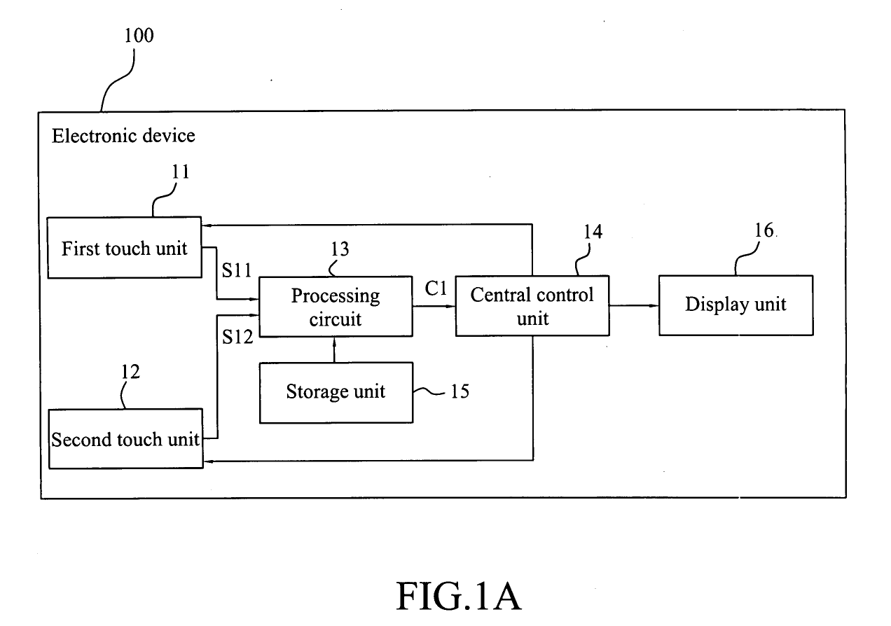

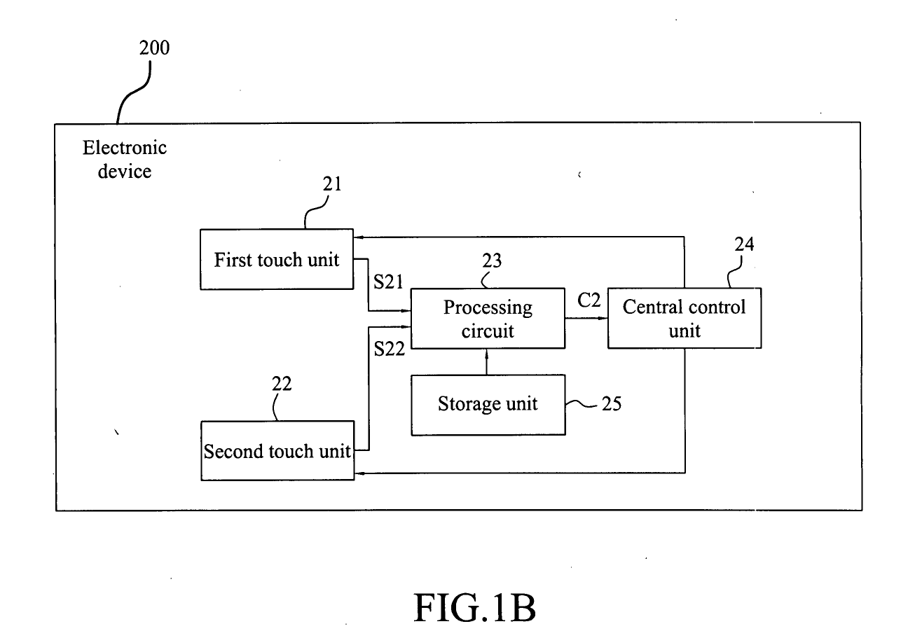

FIG. 1A shows a block diagram of an electronic device in accordance with a first embodiment of present invention. In this embodiment, the electronic device 100 includes a first touch unit 11, a second touch unit 12, a processing circuit 13, a central control unit 14, a storage unit 15 and a display unit 16. The first touch unit 11 and the second touch unit 12 not connecting with the first touch unit 11 are touch buttons. They are electrically connected with the processing circuit 13 via difference wires. Moreover, the electronic device 100 has an operating system that is implemented by the central control unit 14. The central control unit 14 implements an application to control the display unit 16, wherein the application is a part of the operating system, however, those skilled in the art shall understand that the application may be a plug-in which is separated from the operating system.

The first touch unit 11 (as the touch button described above) can generate a first signal S11 in response to a user's first action, wherein the first action is continued for a first touch time on the first touch unit 11.

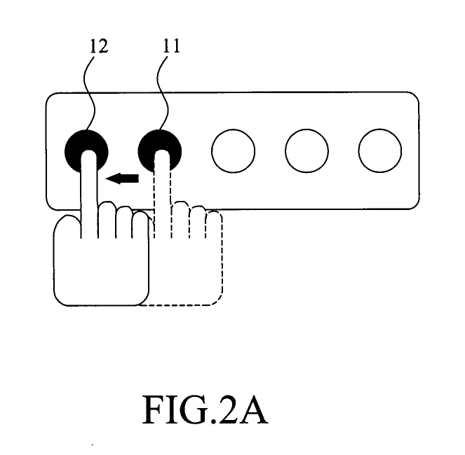

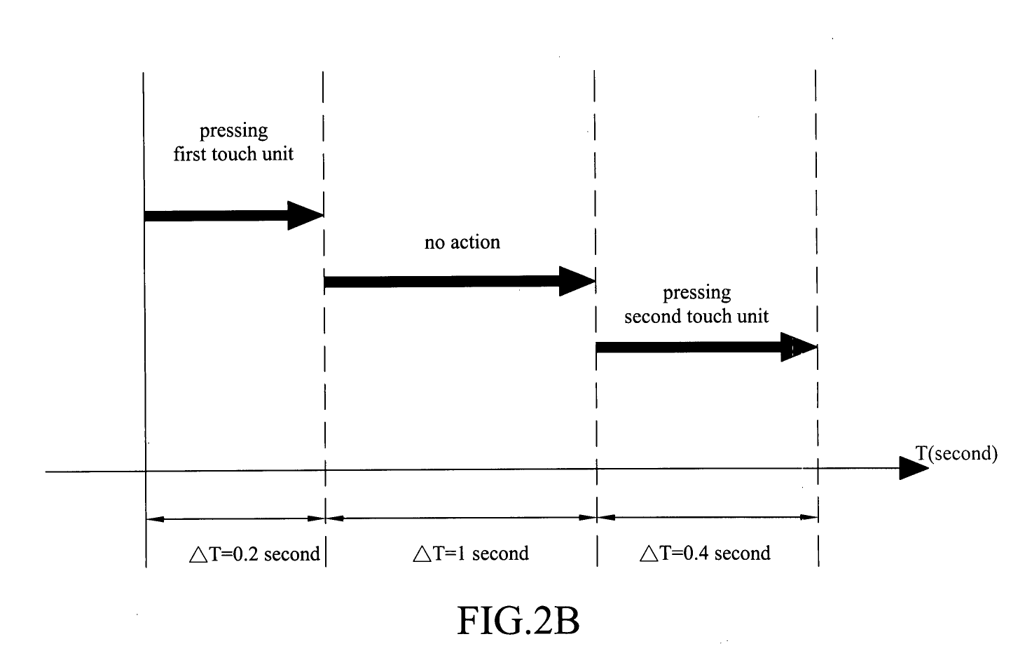

The second touch unit 12 (as the touch button described above) can generate a second signal S12 in response to a user's second action, wherein the second action is continued for a second touch time on the second touch unit 12. The illustration of the second touch unit 12 is the same as the first touch unit 11 described above, and thus is not to be described in details herein. As shown in FIGS. 2A and 2B, for example, a user continuously presses the first touch unit 11 for 0.2 second. Namely, a user continuously presses 0D touch button for 0.2 second. And then no action is taken during the next 1 second. Finally, the user continuously presses the second touch unit 12 for 0.4 second. Therefore, the first touch unit 11 and the second touch unit 12 can respectively generate the first signal S11 and the second signal S12 in response to the user's action times as 0.2 second and 0.4 second. In this embodiment, the first touch unit 11 and the second touch unit 12 can be 0D touch buttons, however, those skilled in the art shall understand that the first touch unit 11 and the second touch unit 12 may respectively be 2D touch button and 0D touch button, or 2D touch button and 1D touch button, wherein 0D touch button is related to the touch time and 1D touch button and 2D touch button are related to the touch position. In addition, the first touch unit 11 and the second touch unit 12 may be, but not limited to, resistive, electrostatic, or capacitance buttons.

The processing circuit 13 can generate a control instruction C1 in response to the first signal S11 and the second signal S12. In this embodiment, the processing circuit 13 may be, but not limited to, a hardware, which is separated from the central control unit 14.

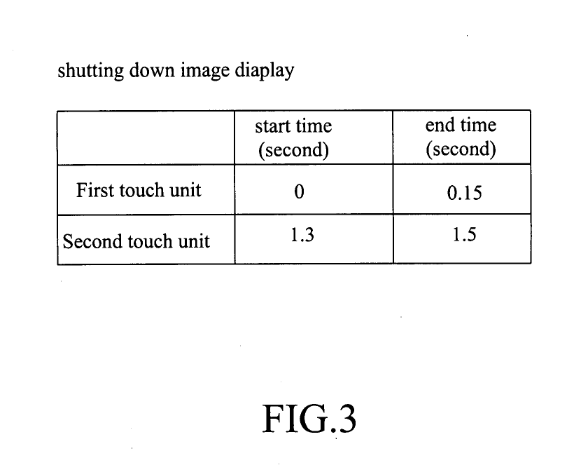

The storage unit 15 having a mapping table is electrically connected with the processing circuit 13 so that the processing circuit 13 maps the first signal S11 and the second signal S12 into the mapping table for generating the control instruction C1. The mapping table comprises of a plurality of sets of the first signal S11 and the second signal S12 related to time for corresponding to the control instructions, wherein one of the sets is illustrated as shown in FIG. 3. If the control instruction C1 is used to shut down the image display, the action on the first touch unit 11 lasts for at least 0.15 second (the difference between the start time and the end time) and the action on the second touch unit 12 lasts for at least 0.2 second (the difference between the start time and the end time). However, those skilled in the art shall understand that a time period of at least 0.5 second during which no action is taken can be provided therebetween in other embodiment.

The central control unit 14 can implement an application in response to the control instruction. In this embodiment, the central control unit 14 can implement the operating system such as Microsoft Mobile, Symbian, OS X, or Linux. Moreover, the central control unit 14 can implement the application to control the display unit 16, for example a LCD display, wherein the application can be a part of the operating system.

The display unit 16 has a predetermined image and is electrically connected with the central control unit 14 so that the central control unit 14 implements the application based on the control instruction for shutting down the display unit 16 and further controlling the display unit 16 to update the predetermined image during on state of the display unit 16. The predetermined image is updated by zooming in or zooming out the predetermined image. In this embodiment, the electronic device 100 further includes, but is not limited to, an audio speaker unit having a predetermined sound volume, a light-emitting unit having a predetermined luminance and a vibration unit having a predetermined vibration (not shown in FIGS. 1˜7). They can be electrically connected with the central control unit 14 so that the central control unit 14 implements the application based on the control instruction for powering on them and further controlling them to update the predetermined image, the predetermined luminance and the predetermined vibration during on state. However, those skilled in the art shall understand that the predetermined sound volume can be updated by increasing or decreasing the predetermined sound volume, the predetermined luminance can be updated by increasing or decreasing the predetermined luminance, and the predetermined vibration can be updated by increasing or decreasing the predetermined vibration.

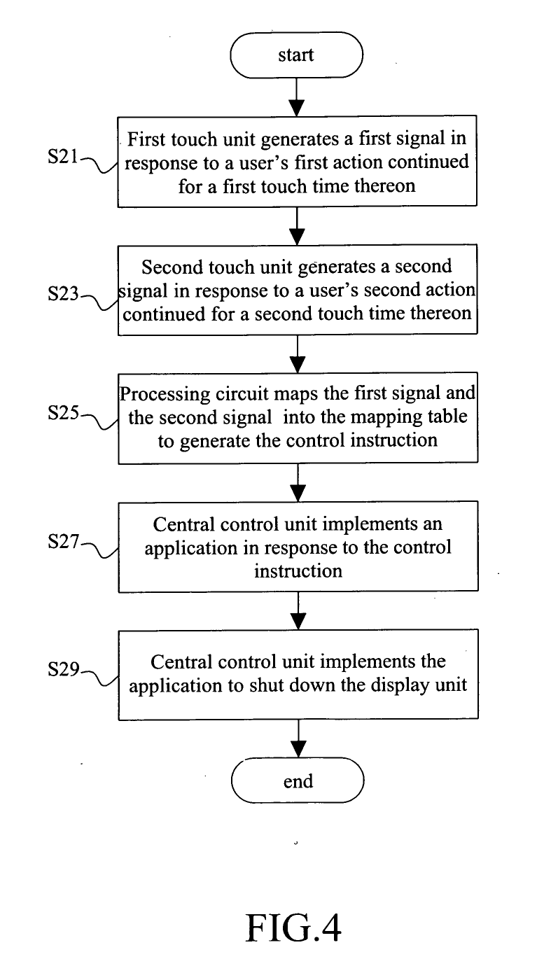

FIG. 4 shows a flowchart of a controlling method in accordance with a first embodiment of present invention. The illustration of the controlling method for the electronic device refers to FIGS. 1A, 2 and 3 simultaneously.

In the present invention, the controlling method for an electronic device is to provide users to use the electronic device having a first touch unit, a second touch unit. Note that the second touch unit is not connecting with the first touch unit. Namely, the first touch unit and the second touch unit can be respectively inputted difference instructions. In this embodiment, the first touch unit 11 and the second touch unit 12 are 0D touch buttons, however, those skilled in the art shall understand that the first touch unit 11 and the second touch unit 12 may be 2D touch button and 0D touch button, or 2D touch button and 1D touch button in other embodiment. If 0D touch button related to the touch time and 2D touch button related to the touch position are used, the only difference is the actions by users in the flow of the controlling method.

The controlling method comprises the following steps. First, first touch unit 11 generates a first signal S11 in response to a user's first action, wherein the first action is continued for a first touch time on the first touch unit 11 (in step S21). Next, the second touch unit 12 generates a second signal S12 in response to a user's second action, wherein the second action is continued for a second touch time on the second touch unit 12 (in step S23). For example, the user continuously presses the first touch unit 11 for a period and then continuously presses the second touch unit 12 for a period. Therefore, the first touch unit 11 and the second touch unit 12 can respectively generate the first signal S11 and the second signal S12 related to time in response to the first touch time and the second touch time.

Next, the processing circuit 13 maps the first signal S11 and the second signal S12 into the mapping table in the storage unit 15 for generating the control instruction C1 (in step S25). Next, the central control unit 14 implements an application in response to the control instruction (in step S27). Finally, the central control unit 14 implements the application to shut down the display unit 16 (in step S29).

Referring to FIG. 1A and FIG. 1B, the first touch unit 11 and the second touch unit 12 of the electronic device 100 in the first embodiment of the present invention are two touch buttons not connecting with each other. However, the first touch unit 21 and the second touch unit 22 of the electronic device 200 in the second embodiment of the present invention are two touch panels not connecting with each other.

The first touch unit 21 of the electronic device 200 can generate a first signal S21 in response to a user's first action, wherein the first action occurs on a first position of the first touch unit 21, and the second touch unit 22 can generate a second signal S22 in response to a user's second action, wherein the second action occurs on a second position of the second touch panel unit so that the processing circuit 23 maps the first signal S21 and the second signal S22 into the mapping table for generating the control instruction C2 and then the central control unit 24 implements an application in response to the control instruction C2 to control the first touch unit 21 and the second touch unit 22 to update display thereof.

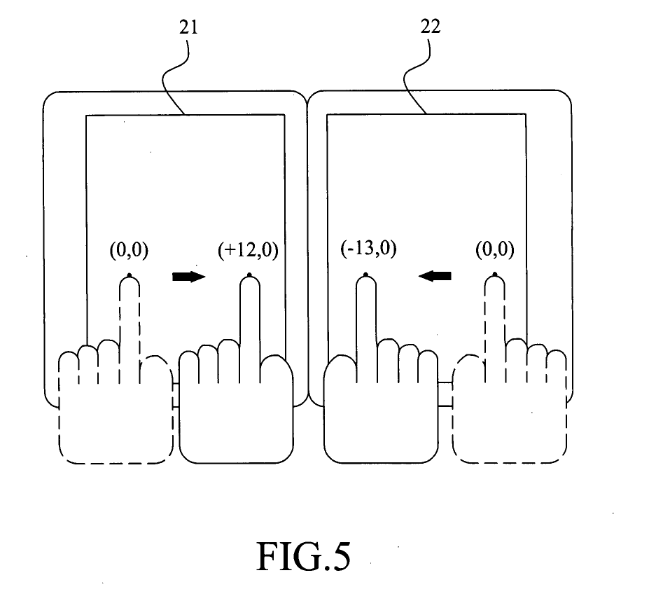

For example, as shown in FIG. 5, the first touch unit 21 (as the first touch panel described above) and the second touch unit 22 (as the second touch panel described above) respectively display difference pages of a book. If the user tries to close the book, the user can move his left and right finger toward the book axis. That is, the left finger touches the first touch unit 21 to change the position thereon (i.e. (0,0) to (+12,0) on the pixel coordinates), and then the right finger touches the second touch unit 22 to change the position thereon (i.e. (0,0) to (−13,0) on the pixel coordinates), so that the first touch unit 21 and the second touch unit 22 can generate the first signal S21 and the second signal S22 in response to the positions. Preferably, the actions on the first position of the first touch unit and the second position of the second touch unit occur at the same time. However, the scope that the actions on the first position of the first touch unit and the second position of the second touch unit occur not at the same time is also claimed by the invention.

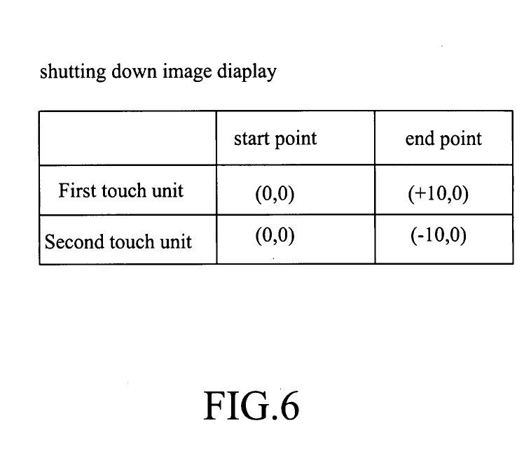

Next, the processing circuit 23 maps the first signal S21 and the second signal S22 into the mapping table in the storage unit 25 for generating the control instruction, wherein the mapping table comprises of a plurality of sets, each set having the first signal S21 and the second signal S22 related to position and a control instruction corresponding to the first and second signals, wherein one of the sets is illustrated as shown in FIG. 6. In other words, as shown in FIG. 6, if the control instruction is used to shut down the image display, at least a change of the position occurs on the first touch unit 21, i.e. (10,0) (the difference between the start point and the end point) and at least a change of the position occurs on the second touch unit 22, i.e. (−10,0) (the difference between the start point and the end point), thus, the central control unit 24 implements the application based on the control instruction for shutting down the first touch unit 21 and the second touch unit 22.

However, those skilled in the art shall understand that the user can conveniently use the touch panel with the image control by intuition. For example, the first touch unit 21 and the second touch unit 22 respectively display difference pages of a book. If the user tries to page down, the user can hold his left finger for not changing the position (i.e. (0,0) to (0,0) on the pixel coordinates) and move right finger for changing the position (i.e. (0,0) to (−13,0) on the pixel coordinates) so as to update display of the first touch unit 21 and the second touch unit 22.

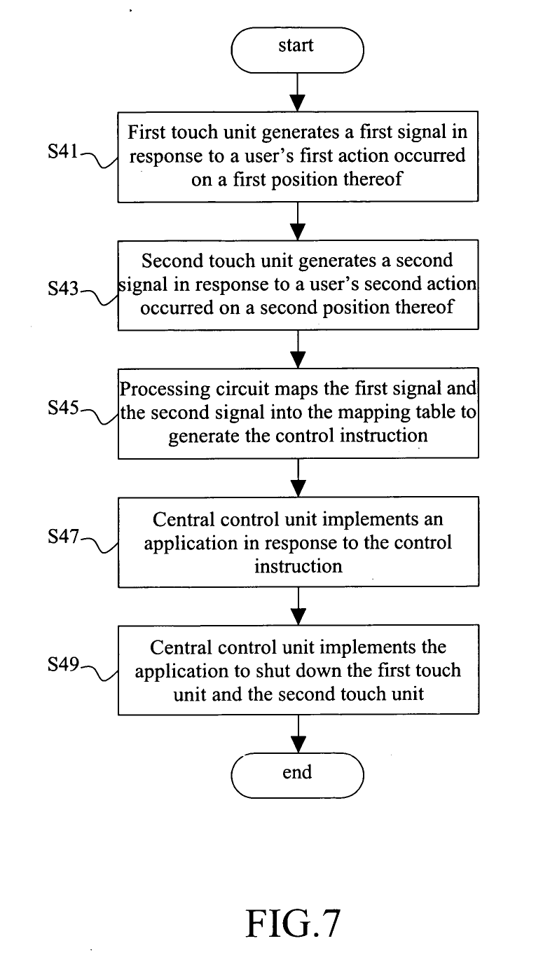

FIG. 7 shows a flowchart of a controlling method in accordance with a second embodiment of present invention. The illustration of the controlling method for the electronic device refers to FIGS. 1B, 5 and 6 simultaneously. In this embodiment, the controlling method comprises the following steps. First, the first touch unit 21 generates a first signal S21 in response to a user's first action, wherein the first action occurs on a first position of the first touch unit 21 (in step S41). Next, the second touch unit 22 generates a second signal S22 in response to a user's second action, wherein the second action occurs on a second position of the second touch unit 22 (in step S43). Next, the processing circuit 23 maps the first signal S21 and the second signal S22 into the mapping table in the storage unit 25 for generating the control instruction (in step S45). Next, the central control unit 24 implements an application in response to the control instruction (in step S47). Finally, the central control unit 24 implements the application to shut down the first touch unit 21 and the second touch unit 22 (in step S49).

Although the specific embodiments of the present invention have been illustrated and described, it is to be understood that the invention is not limited to those embodiments. One skilled in the art may make various modifications without departing from the scope or spirit of the invention.

What is claimed is:

1. An electronic device, comprising:
a first touch unit for generating a first signal in response to a user's first action;
a second touch unit not connecting with the first touch unit, for generating a second signal in response to the user's second action;
a processing circuit for generating a control instruction in response to the first signal and the second signal; and
a central control unit for implementing an application in response to the control instruction.

2. The electronic device of claim 1, wherein the first touch unit and the second touch unit are touch buttons.

3. The electronic device of claim 1, wherein the first action is continued for a first touch time on the first touch unit and the second action occurs on a second position of the second touch unit.

4. The electronic device of claim 1, wherein the first action is continued for a first touch time on the first touch unit and the second action is continued for a second touch time on the second touch unit.

5. The electronic device of claim 1, wherein the first action occurs on a first position of the first touch unit and the second action occurs on a second position of the second touch unit.

6. The electronic device of claim 1, further comprising a storage unit having a mapping table, the storage unit being electrically connected with the processing circuit so that the processing circuit maps the first signal and the second signal into the mapping table for generating the control instruction.

7. The electronic device of claim 1, further comprising an audio speaker unit having a predetermined sound volume, the audio speaker unit being electrically connected with the central control unit so that the central control unit implements the application based on the control instruction for controlling the audio speaker unit to update the predetermined sound volume.

8. The electronic device of claim 7, wherein the predetermined sound volume is updated by increasing the predetermined sound volume.

9. The electronic device of claim 1, further comprising a display unit having a predetermined image, the display unit being electrically connected with the central control unit so that the central control unit implements the application based on the control instruction for controlling the display unit to update the predetermined image.

10. The electronic device of claim 9, wherein the predetermined image is updated by zooming in the predetermined image.

11. The electronic device of claim 1, further comprising a light-emitting unit having a predetermined luminance, the light-emitting unit being electrically connected with the central control unit so that the central control unit implements the application based on the control instruction for controlling the display unit to update the predetermined luminance.

12. The electronic device of claim 11, wherein the predetermined luminance is updated by increasing the predetermined luminance.

13. The electronic device of claim 1, further comprising a vibration unit having a predetermined vibration, the vibration unit being electrically connected with the central control unit so that the central control unit implements the application based on the control instruction for controlling the display unit to update the predetermined vibration.

14. The electronic device of claim 13, wherein the predetermined vibration is updated by increasing the predetermined vibration.

15. The electronic device of claim 1, wherein the first touch unit is a first touch panel and the second touch unit is a second touch panel so that the central control unit implements the application for controlling the first touch panel and the second touch panel to update display of the first touch panel and the second touch panel.

16. A controlling method for an electronic device, wherein the electronic device comprises a first touch unit, a second touch unit, a processing circuit and a central control unit, wherein the second touch unit is not connecting with the first touch unit, the controlling method comprising:
(A) generating a first signal by the first touch unit in response to a user's first action;
(B) generating a second signal by the second touch unit in response to the user's second action;
(C) generating a control instruction by the processing circuit in response to the first signal and the second signal; and
(D) implementing an application by the central control unit in response to the control instruction.

17. The controlling method of claim 16, wherein the electronic device further comprises a storage unit having a mapping table, the storage unit being electrically connected with the processing circuit so that, in the step (C), the processing circuit maps the first signal and the second signal into the mapping table and then generates the control instruction.

18. The controlling method of claim 16, wherein the electronic device further comprising a display unit having a predetermined image, the display unit being electrically connected with the central control unit, wherein the controlling method further comprises:
(E) the central control unit implementing the application based on the control instruction for controlling the display unit to update the predetermined image.

19. The controlling method of claim 16, wherein the electronic device further comprises an audio speaker unit having a predetermined sound volume, the audio speaker unit being electrically connected with the central control unit, wherein the controlling method further comprises:
(E) the central control unit implementing the application based on the control instruction for controlling the audio speaker unit to update the predetermined sound volume.

20. The controlling method of claim 16, wherein the first touch unit and the second touch unit are touch buttons.

21. The controlling method of claim 16, wherein the first touch unit in step (A) is a first touch panel and the second touch unit in step (B) is a second touch panel unit, so that the controlling method further comprises
(E) the central control unit implementing the application based on the control instruction for controlling the first touch panel and the second touch panel to update display of the first touch panel and the second touch panel.

22. The controlling method of claim 16, wherein the first action is continued for a first touch time on the first touch unit and the second action is continued for a second touch time on the second touch unit.

23. The controlling method of claim 16, wherein the first action occurs on a first position of the first touch unit and the second action occurs on a second position of the second touch unit.

24. The controlling method of claim 16, wherein the first action is continued for a first touch time on the first touch unit and the second action occurs on a second position of the second touch unit.
